(19) United States
(12) Patent Application Publication
(10) Pub. No.: US 2012/0109616 A1
(43) Pub. Date: May 3, 2012

(54) Method to synchronize and synthesize bus transaction traces for an un-timed virtual environment

(75) Inventors: Hsiao-Wei Chang, Hsinchu City (TW); Pei-Sheng Su, Hsinchu (TW); Sheng-Hsun Cho, New Taipei City (TW)

(73) Assignee: Global Unichip Corporation, Hsinchu City (TW)

(21) Appl. No.: 13/064,159

(22) Filed: Mar. 9, 2011

(30) Foreign Application Priority Data
Nov. 2, 2010 (TW) 099137569

(51) Int. Cl. G06G 7/62

(52) U.S. Cl. 703/13

(57) ABSTRACT

The invention discloses to a method to synchronize and synthesize bus transaction traces for an un-timed virtual environment. The steps are the followings providing a simulation environment and an emulation environment; recording the transaction of intellectual property (IP) through the bus, collecting the plurality of continuously transferred transaction set, connecting a plurality of transaction blocks recorded from the simulation environment, and assigning a corresponding number to the transaction block; labeling a begin time mark and a transfer time mark; initializing a plurality of parameters; taking a transaction block; judging the type of the transaction block respectively; and after respectively assuring that the transaction block is the last transaction block in the simulated transaction block series, output these parameter values.

### BACKGROUND OF THE INVENTION

1. Field of the Invention

This invention relates to a method to synchronize and synthesize bus transaction traces for an un-timed virtual environment, particularly to a synchronized and synthesized method using the hybrid environment of physical environment and simulation environment.

2. Description of the Prior Art

In the prior art, the electronic system level design is a trend for the design of System-On-Chip (SOC). It was started to be used in the high-level abstract design to module intellectual property (IP) the user can process the identification of design through the electronic system level design. The virtual design platform includes the developable intellectual property, and the sub-module intellectual property can be provided to the virtual platform through high-level abstract design of intellectual property.

In the most of prior art, it was focused on the pure virtual environment, such as US Patent No. 2006/0282233 A1. However, there are many drawbacks by only using the virtual environment to carry out the above-mentioned design. Thus, it is necessary to have a novel method for the electronic system level design, in order to obtain more efficient design.

### SUMMARY OF THE INVENTION

The purpose of the invention is to provide a method to synchronize and synthesize bus transaction traces for an un-timed virtual environment, wherein the emulation traces are used to compensate un-timed simulation traces, so that make it possible to do performance analysis using a hybrid system, and can high-speed running and running correctness in conventional time.

In order to reach the above-mentioned purpose, the invention provides a method to synchronize and synthesize bus transaction traces for an un-timed virtual environment. The steps of the method are the followings: providing a simulation environment and an emulation environment; recording the transaction of intellectual property (IP) through the bus in the simulation environment and the emulation environment, and collecting the plurality of continuously transferred transaction set from one IP to another IP to form a transaction block, and connecting a plurality of transaction blocks recorded from the simulation environment to a simulated transaction block series according to the time sequence, and assigning a corresponding number to the plurality of transaction blocks; labeling a begin time mark and a transfer time mark in the transaction block; initializing a plurality of parameters for the corresponding transaction block; taking one of the transaction block from the simulated transaction block series; judging the type of the transaction block, respectively according to the type of the transaction block, and updating a plurality of parameters of the transaction block according to the transaction of the transaction block; and after respectively assuring that the transaction block is the last transaction block in the simulated transaction block series, outputting these parameter values.

Compared to the prior, the invention does not only operate in the simulation environment. In fact, the invention utilizes the hybrid system of emulation environment and simulation environment to solve the drawback in single environment, so that still can assure high-speed execution and correctness within the conventional time.

Therefore, the advantage and spirit of the invention can be understood further by the following detail description of invention and attached Figures

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a graph illustrating the flow chart of a method to synchronize and synthesize bus transaction traces for an un-timed virtual environment for an embodiment of the invention

FIG. 2 is a graph illustrating the diagram of a method to synchronize and synthesize bus transaction traces for an un-timed virtual environment for an embodiment of the invention

### DESCRIPTION OF THE PREFERRED EMBODIMENT

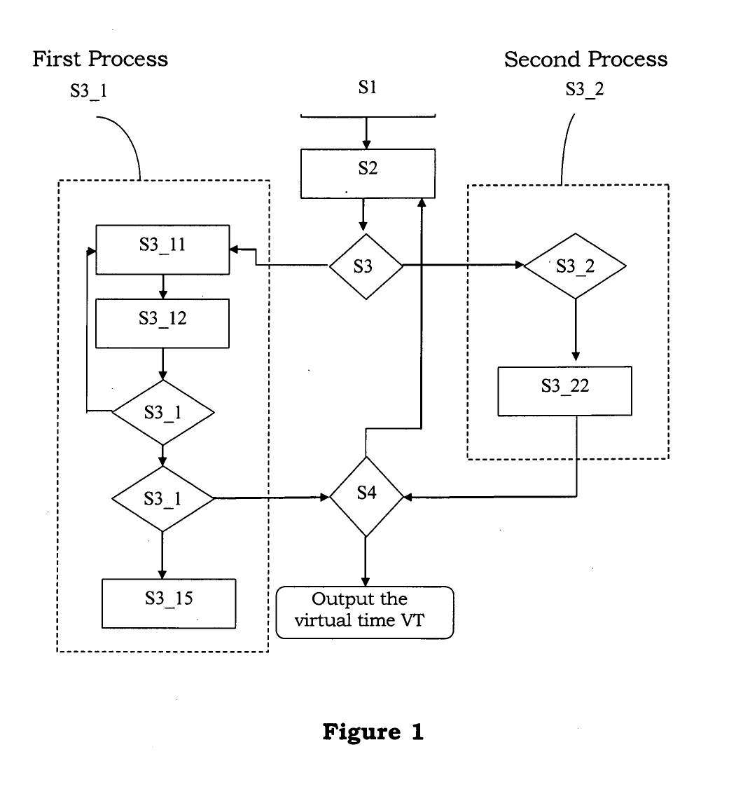

FIG. 1 is a graph illustrating the flow chart of a method to synchronize and synthesize bus transaction traces for an un-timed virtual environment for an embodiment of the invention. In the embodiment, the method to synchronize and synthesize bus transaction traces for an un-timed virtual environment 10 starts at Step S1, which provides a simulation environment and an emulation environment. In the simulation environment and the emulation environment, respectively recording the transaction of intellectual property (IP) through the bus, collecting the plurality of continuously transferred transaction set from one IP to another IP to form a transaction block, and according to the time sequence, connecting a plurality of transaction blocks recorded from the simulation environment to form a simulated transaction block series, and respectively assigning the corresponding number to the plurality of transaction blocks; labeling the beginning time mark and the transferring time mark in the transaction block; initializing a plurality of parameters for the corresponding transaction block. Wherein, the parameters comprise virtual time (VT), virtual idle time (VIT), virtual transfer time (VTT) and virtual contention time (VCT). In the Step S1, the above-mentioned parameters are initialized first. It means that these parameters are initialized as VT=0, VIT=0, VTT=0 and VCT=0, respectively.

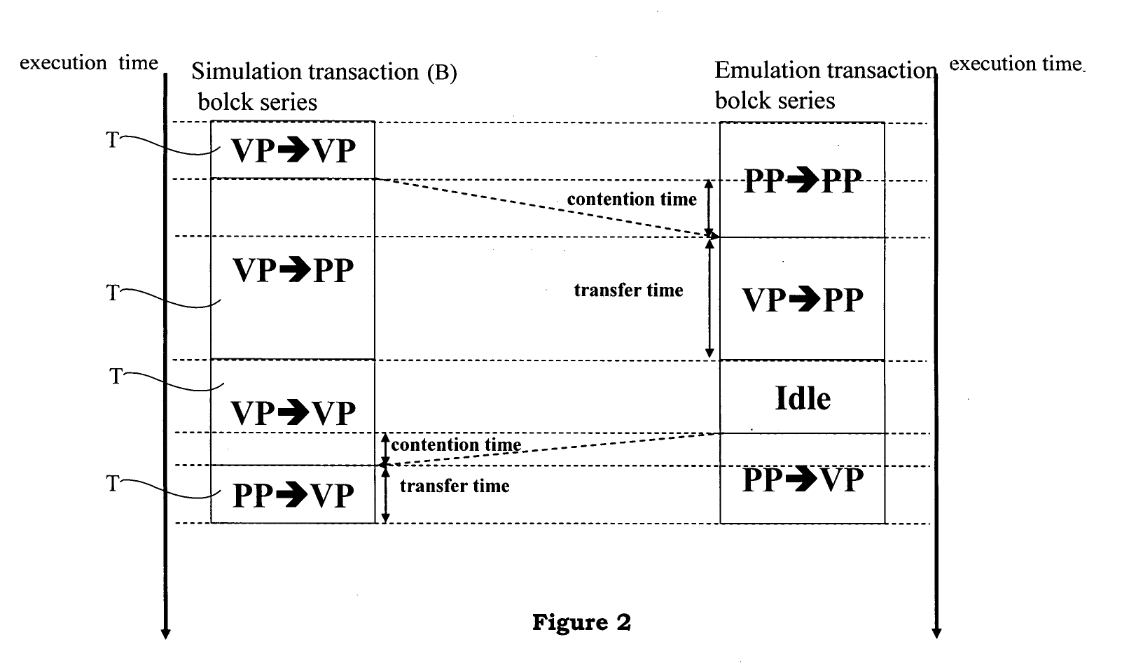

Then, in the Step S2, as shown in FIG. 2 takes transaction block B from the simulated transaction block series. In the Step S3, judge the type of transaction block B to see whether it is the virtual IP (VP) or the physical IP (PP). It has to note that the type is determined in accordance with the transaction source, objective and orientation. It can be classified as transferring the transaction from physical IP (PIP) to physical IP (PIP), transferring the transaction from physical IP (PIP) to virtual IP (VIP), transferring the transaction from virtual IP (VIP) to physical IP (PIP), and transferring the transaction from virtual IP (VIP) to virtual IP (VIP). In addition, there are four types of transaction block, such as continuously transferring the transaction from PIP to PIP (PP→PP), continuously transferring the transaction from PIP to VIP (PP→VP), continuously transferring the transaction from VIP to VIP (VP→VP), and continuously transferring the transaction from VIP to PIP (VP→PP). All are shown in FIG. 2.

In the Step S3, according to the type of transaction block B, if it is transferred from PP to VP or from VP to VP, then conducting a first process, and if it is transferred from VP to PP, then conducting a second process.

Wherein, in the Step S3_11 of the first process S3_1, transaction T is taken from the transaction block B in accordance with the time sequence, as shown in FIG. 2. Transaction block B is initialized, so that the predicted total transfer time for a transaction block in the initialized transaction block B will be B_ptt=0. Then in the Step S3_12, check transaction T via table look up to obtain a predicted total transfer time of the transaction T_ptt, and update the predicted total transfer time of transaction block B as B_ptt=B_ptt+T_ptt, wherein B_ptt represents the predicted total transfer time of transaction block, and T_ptt represents the predicted total transfer time of transaction. In the Step S3_13, judge whether transaction T is the last transaction of transaction block B again. If the answer is no, return to the Step S3_11 to continue. If the answer is yes, judge whether the first transaction block B is transferred from PP to VP. If the transaction block B is transferred from PP to VP, then take a begin time B_bt and a total transfer time B_tt of transaction block B from the simulation environment. Then execute the Step S3_15, in order to update VT, VIT and VTT as the followings:

When B_bt+VIT+VTT+VCT=<VT,

VCT=VCT+VT−(B_bt+VIT+VTT+VCT);

When B_bt+VIT+VTT+VCT>VT,

VT=VT+VT−(B_bt+VIT+VTT+VCT);

VTT=VTT−B_tt+B_ptt;

VT=VT+B_ptt.

In the Step S4, judge whether transaction block B is the last transaction block in the transaction block series again. If transaction block B is the last transaction block, then output VT and stop the execution, otherwise return to the Step S2.

In addition, in the Step S3, if the type of transaction block B is not transferred from PP to VP or from VP to VP, then conduct the Step S3_21 of the second process S3_2. Firstly, take a block time record B_bt and a transfer time B_tt of transaction block B. Then in the Step S3_22, update VT and VIT as the followings:

When B_bt+VIT+VTT+VCT<VT,

VT=VT+VT−(B_bt+VIT+VTT+VCT);

When B_bt+VIT+VTT+VCT>VT,

VIT=VIT+(B_bt+VIT+VTT+VCT)−VT;

VT=VT+B_tt.

In the Step S4, judge whether transaction block B is the last transaction block in the transaction block series again or not. If transaction block B is the last transaction block, then output VT and stop the execution, otherwise return to the Step S2.

In addition, it is able to refer to FIG. 2 for the diagram of the above-mentioned flow chart. FIG. 2 is a graph illustrating the diagram of a method to synchronize and synthesize bus transaction traces for an un-timed virtual environment for an embodiment of the invention. In the embodiment, if there is continuous transaction block from VIP to PIP (VP→PP) in the simulation environment, then there is corresponding continuous transaction block from VIP to PIP in the emulation environment. Wherein, the transaction block possesses its own contention time and transfer time. The begin time at VP→PP in the simulation environment is the same as or later than that in the corresponding emulation environment. Meantime, due to the transaction block possesses the contention time, the VP→PP in the emulation environment is later than that in the corresponding simulation environment.

It is understood that various other modifications will be apparent to and can be readily made by those skilled in the art without departing from the scope and spirit of this invention. Accordingly, it is not intended that the scope of the claims appended hereto be limited to the description as set forth herein, but rather that the claims be construed as encompassing all the features of patentable novelty that reside in the present invention, including all features that would be treated as equivalents thereof by those skilled in the art to which this invention pertains.

What is claimed is:

1. A method to synchronize and synthesize bus transaction traces for an un-timed virtual environment, comprising:
providing a simulation environment and an emulation environment, respectively recording a transaction of intellectual property through a bus and collecting a plurality of continuously transferred transaction set from one intellectual property to another intellectual property to form a transaction block in the simulation environment and the emulation environment and connecting a plurality of transaction blocks recorded from the simulation environment to form a simulated transaction block series according to a time sequence and assigning a corresponding number to the plurality transaction blocks;
labeling a beginning time mark and a transferring time mark in the plurality transaction blocks;
initializing a plurality of parameters from the plurality of corresponding transaction blocks;
taking a transaction block from the simulated transaction block series;
judging the type of the transaction block and updating a plurality of parameters of the transaction block according to the type of the transaction block and a transaction; and
after assuring that the transaction block being a last transaction block in the simulated transaction block series, outputting these parameter values.

2. The method according to claim 1, wherein the initialized parameters further comprises a virtual time (VT), a virtual idle time (VIT), a virtual transfer time (VTT) and a virtual contention time (VCT).

3. The method according to claim 2, wherein the initialized parameters comprises VT=0, VIT=0, VTT=0 and VCT=0, respectively.

4. The method according to claim 2, wherein judging a type of the transaction block comprises whether the transaction being virtual IP or the physical IP.

5. The method according to claim 4, wherein the type of the transaction block further comprises:
if transferred from physical IP to virtual IP or from virtual IP to virtual IP, then conducting a first process; and
if transferred from virtual IP to physical IP, then conducting a second process.

6. The method according to claim 5, wherein the first process comprises:
taking a transaction from the transaction block; and
initializing the transaction block so that a predicted total transferring time for the transaction block in an initialized transaction block being B_ptt=0.

7. The method according to claim 6, wherein the first process further comprises:
an checking table for a transaction to obtain a predicted total transfer time of the transaction as T_ptt, and updating predicted total transfer time of the transaction block as B_ptt=B_ptt+T_ptt.

8. The method according to claim 7, wherein the first process further comprises:
if the transaction in transaction block being judged as a last transaction, then judge whether the transaction block being transferred from the physical IP to the virtual IP, otherwise repeating the first process.

9. The method according to claim 8, wherein the first process further comprises:
if the transaction block being transferred from the physical IP to the virtual IP, then taking a beginning time B_bt and a total transferring time B_tt from the transaction block.

10. The method according to claim 9, the first process further comprises updating the VT, the VIT and the VTT:
VCT=VCT+VT−(B_bt+VIT+VTT+VCT),
when B_bt+VIT+VTT+VCT=<VT;
VT=VT+VT−(B_bt+VIT+VTT+VCT),
when B_bt+VIT+VTT+VCT>VT; and
VTT=VTT−B_tt+B_ptt.

11. The method according to claim 10, wherein the VT further comprises VT=VT+B_ptt.

12. The method according to claim 11, wherein judging whether the transaction block being the last transaction block in the transaction block series, if the transaction block being the last transaction block, then outputting the VT, otherwise taking a next transaction block from the simulated transaction block series.

13. The method according to claim 5, wherein the second process comprises: taking a block time record B_bt and a transfer time B_tt from the transaction block B.

14. The method according to claim 13, the second process further comprises:
updating the VT and the VIT:
VT=VT+VT−(B_bt+VIT+VTT+VCT),
when B_bt+VIT+VTT+VCT<VT;
VIT=VIT+(B_bt+VIT+VTT+VCT)−VT,
when B_bt+VIT+VTT+VCT>VT, and
VT=VT+B_tt.

15. The method according to claim 14, the steps further comprising: judging whether the transaction block being the last transaction block in the transaction block series, if the transaction block being the last transaction block, then outputting the VT, otherwise taking a transaction block from the transaction block series.
